(19) United States
(12) Patent Application Publication
(10) Pub. No.: US 2006/0019646 A1
(43) Pub. Date: Jan. 26, 2006

(54) Network support for mobile handset application customization

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 10/895,714

(22) Filed: Jul. 21, 2004

(51) Int. Cl. H04M 3/00

(52) U.S. Cl. 455/419; 455/418

(57) ABSTRACT

Embodiments of the system and method allow a mobile terminal to download customization applications from a network. The method may have the steps of: sending, by a mobile terminal, a request to the network to download mobile terminal functionality; verifying, by the network, authorized access for the mobile terminal to this functionality; and downloading, by the network, the functionality to the mobile terminal.

### TECHNICAL FIELD

The present invention relates generally to telecommunication, and in particular to network capability to support a customized mobile terminal application.

### BACKGROUND

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

The features described above present only a sample of features that are capable of, or have already been, implemented into wireless phone systems. Any individual feature is capable of implementation into some or all of the wireless systems using the modulation schemes mentioned above.

Mobile subscribers are utilizing mobile terminals (also referred to as cell phones, mobile phones, laptop computers, etc.) for a variety of uses in addition to voice communications, Emails and SMS messages (e.g., camera phones, etc.). There are occasions when it is desirable to customize the functionality of a mobile terminal. It is beneficial to do this from the network where different applications for implementing different functionalities may be stored. However, this is not possible in the current state of the art.

Thus, there is a need in the prior art for the user to be able to download specific mobile terminal applications to increase the utility of the mobile terminal (e.g., operate in a WI-FI mode within a CDMA RF-degraded environment, operate as a cordless phone, operate as an RF (e.g., Bluetooth, etc.) remote control, etc.).

### SUMMARY

The invention in one implementation encompasses a system that is structure to allow a mobile terminal to download customization applications from a network. One embodiment of the system may have: a terminal operatively connected to a network, the network having a call controller; a call controller in the network operatively coupled to a terminal functionality module; a first storage in the network in which is stored a plurality of customization applications, the first storage operatively coupled to the terminal functionality module; a second storage in the network in which is stored data indicative of authorization for the terminal, the second storage operatively coupled to the functionality module; a request from the terminal that initiates, by the network, downloading of a respective customization application of the plurality of customization applications.

Another implementation of the present invention encompasses a method that may have the steps of: sending, by a mobile terminal, a request to the network to download mobile terminal functionality; verifying, by the network, authorized access for the mobile terminal to this functionality; and downloading, by the network, the functionality to the mobile terminal.

### BRIEF DESCRIPTION OF THE DRAWINGS

Features of exemplary implementations of the invention will become apparent from the description, the claims, and the accompanying drawings in which:

FIG. 1 depicts a block diagram that illustrates elements of a system according to one embodiment for providing a feature that allows a mobile subscriber to download customization applications from a network.

FIG. 2 illustrates a very general flow chart of logical operational steps that may be followed in accordance with one embodiment of the present method and system.

FIG. 3 illustrates a more specific flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

An embodiment of the present system and method may provide a methodology for the network to recognize that a particular mobile terminal has the capability to support a customized mobile terminal application. Another methodology may be for the network to offer, on demand to a mobile subscriber of a mobile terminal, a menu of customized mobile terminal applications. A further methodology may be for the network to reorganize subscriber requests to select a particular customized mobile terminal application for downloading. Yet another methodology may be for the network to interact with the mobile terminal to switch the mobile terminal into or out of an alternate application as required in order to process voice calls.

Although the present system and method may be used with any type of network (wired and wireless, for example), a subscriber may typically be a mobile subscriber who uses a mobile terminal (also referred to as mobile phone, a cell phone, mobile handset, or car phone).

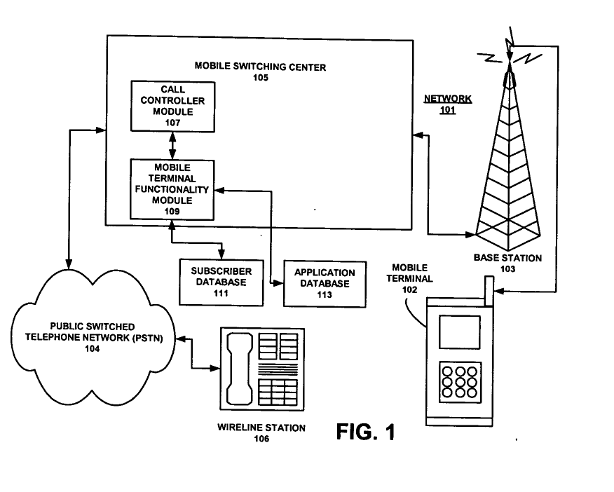

In the FIG. 1 embodiment a network 101 is operatively connected to at least one mobile terminal 102. As is known the network 101 may have at least one base station 103, which is operatively coupled to a mobile switching center 105, and which is wirelessly coupled to the mobile terminal 102. The mobile switching center 105 in the network 101 may also have a call controller module 107 operatively coupled to the base station 103 and to a mobile terminal functionality module 109. A subscriber database 111 and an application database 113 may also be operatively coupled to the mobile terminal functionality module 109.

The network 101 may be, or may be part of, one or more of a telephone network, a local area network (“LAN”), the Internet, and a wireless network. In the depicted embodiment, a public switched telephone network (PSTN) 104 may be operatively coupled to the mobile switching center 105. The PSTN 104 routes calls to and from mobile users (such as mobile terminal 102) through the mobile switching center 105. The PSTN 104 may also route calls from and to wireline stations 106. The PSTN 104 generally may be implemented as a worldwide voice telephone network accessible to all those with telephones and access privileges (e.g., AT&T long distance network).

A primary mode of the mobile terminal 102 may be a call mode, and the network 101 may be structured to interact with the mobile terminal 102 to switch the mobile terminal 102 into or out of an alternate mode as required in order to process voice calls in the call mode. The alternate mode of the mobile terminal 102 may be implemented by the downloaded application. The alternate mode of the mobile terminal 102 may be overridden by network 101 for an incoming call to the mobile terminal 102.

The respective customization application may be one of at least an application to operate the mobile terminal 102 in a WI-FI mode within a CDMA RF-degraded environment, an application to operate the mobile terminal 102 as a cordless phone, and an application to operate the mobile terminal 102 as a radio frequency remote control device. Numerous other customization applications are possible.

The network may also have a menu of customized mobile terminal applications, the menu being offered to the mobile terminal 102 by the network 101 when a demand is received from the mobile terminal 102. The demand may be the request, or may be a separate communication from the mobile terminal 102 to the network 101.

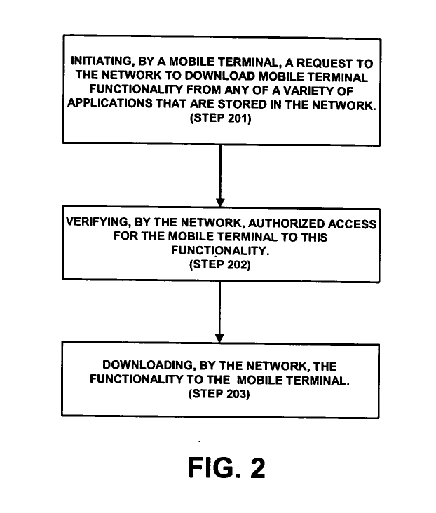

FIG. 2 depicts an embodiment of the present method in which (step 201) a mobile terminal may send a request to the network (in the form of a soft key, or a dialed number sequence, a voice command, etc.) to download mobile terminal functionality. Pending verification of authorized access to this functionality (step 202), the network may proceed to download the functionality to the mobile terminal (step 203).

The functionality may be implemented by a respective application of a plurality of applications that are stored in the network. A primary application of the mobile terminal may be a call application, and a downloaded application may be an alternate application. The network may interact with the mobile terminal to switch the mobile terminal into or out of the alternate application as required in order to process voice calls in the call application.

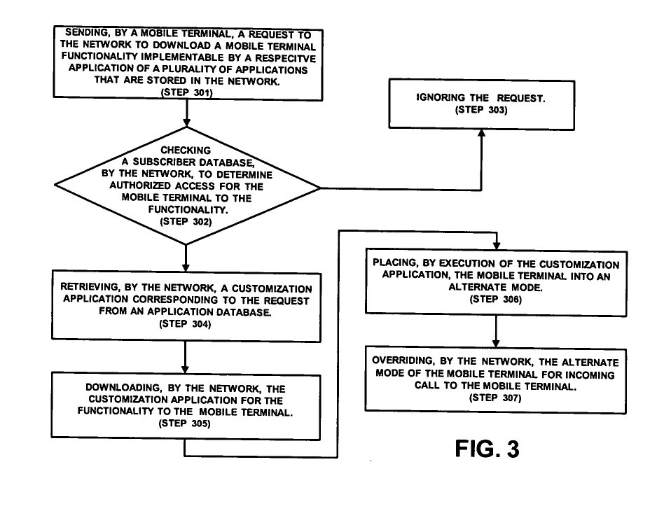

FIG. 3 depicts an embodiment of the present method for allowing a mobile terminal to download customization applications from a network. An embodiment of this method may have the steps of: sending, by a mobile terminal, a request to the network to download mobile terminal functionality from at least one application that is stored in the network for the mobile terminal (step 301); checking a subscriber database, by the network, to determine authorized access for the mobile terminal to the functionality (step 302); ignoring the request, if the mobile terminal is not authorized (step 303); retrieving, by the network, from an application database a customization application corresponding to the request, if the mobile terminal is authorized (step 304); downloading to the mobile terminal, by the network, the retrieved customization application for the functionality (step 305); placing, by execution of the customization application, the mobile terminal into an alternate mode (step 306); and overriding, by the network, the alternate mode of the mobile terminal for incoming call to the mobile terminal (step 307).

The primary mode of the mobile terminal may be a call mode. The network may then interact with the mobile terminal to switch the mobile terminal into or out of the alternate mode as required in order to process voice calls in the call mode.

The request may be activated by at least one of a soft key, a dialed number sequence, and a voice input command at the mobile terminal. The customization application may be one of at least an application to operate the mobile terminal in a WI-FI mode within a CDMA RF-degraded environment, an application to operate the mobile terminal as a cordless phone, and an application to operate the mobile terminal as a radio frequency remote control device.

Thus embodiments of the present system and method fulfill a need in the prior art for allowing a user to download specific mobile terminal applications to increase the utility of the mobile terminal.

The present system and method may be used with non-mobile phones and terminals, as well as, mobile phones and mobile terminals. Also, different types of data storage devices may be used with the present method and system. For example, a data storage device may be one or more of a magnetic, electrical, optical, biological, and atomic data storage medium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method for allowing a mobile terminal to download customization applications from a network, comprising the steps of:
sending, by a mobile terminal, a request to the network to download mobile terminal functionality;
verifying, by the network, authorized access for the mobile terminal to this functionality; and
downloading, by the network, the functionality to the mobile terminal.

2. The method according to claim 1, wherein the request is activated by at least one of a soft key, a dialed number sequence, and a voice input.

3. The method according to claim 1, wherein the functionality is one of at least a functionality to operate the mobile terminal in a WI-FI mode within a CDMA RF-degraded environment, a functionality to operate the mobile terminal as a cordless phone, and a functionality to operate the mobile terminal as a radio frequency remote control device.

4. The method according to claim 1, wherein the method further comprises the network offering, on demand to a mobile subscriber of a mobile terminal, a menu of customized mobile terminal applications.

5. The method according to claim 1, wherein the functionality is implemented by a respective application of a plurality of applications that are stored in the network.

6. The method according to claim 5, wherein a primary application of the mobile terminal is a call application, wherein the respective application is an alternate application, and wherein the method further comprises the network interacting with the mobile terminal to switch the mobile terminal into or out of an alternate application as required in order to process voice calls in the call application.

7. A method for allowing a mobile terminal to download customization applications from a network, comprising the steps of:
sending, by a mobile terminal, a request to the network to download mobile terminal functionality from at least one application that is stored in the network for the mobile terminal;
checking a subscriber database, by the network, to determine authorized access for the mobile terminal to the functionality;
ignoring the request, if the mobile terminal is not authorized;
retrieving, by the network, from an application database a customization application corresponding to the request, if the mobile terminal is authorized;
downloading to the mobile terminal, by the network, the retrieved customization application for the functionality; and
placing, by execution of the customization application, the mobile terminal into an alternate mode.

8. The method according to claim 5, wherein a primary mode of the mobile terminal is a call mode, and wherein the method further comprises the network interacting with the mobile terminal to switch the mobile terminal into or out of the alternate mode as required in order to process voice calls in the call mode.

9. The method according to claim 1, wherein the method further comprises overriding, by the network, the alternate mode of the mobile terminal for in coming call to the mobile terminal.

10. The method according to claim 1, wherein the request is activated by at least one of a soft key, a dialed number sequence, and a voice input command.

11. The method according to claim 1, wherein the customization application is one of at least an application to operate the mobile terminal in a WI-FI mode within a CDMA RF-degraded environment, an application to operate the mobile terminal as a cordless phone, and an application to operate the mobile terminal as a radio frequency remote control device.

12. A system structured to allow a terminal to download customization applications from a network, comprising:
a terminal operatively connected to a network, the network having a call controller;
a call controller in the network operatively coupled to a mobile terminal functionality module;
a first storage in the network in which is stored a plurality of customization applications, the first storage operatively coupled to the mobile terminal functionality module;
a second storage in the network in which is stored data indicative of authorization for the terminal, the second storage operatively coupled to the mobile terminal functionality module;
a request from the terminal that initiates, by the network, downloading of a respective customization application of the plurality of customization applications;

13. The system according to claim 5, wherein a primary mode of the mobile terminal is a call mode, and wherein the network is structured to interact with the mobile terminal to switch the mobile terminal into or out of the alternate mode as required in order to process voice calls in the call mode.

14. The system according to claim 1, wherein the network is structured to override the alternate mode of the mobile terminal for in coming call to the mobile terminal.

15. The system according to claim 1, wherein the request is activated by at least one of a soft key, a dialed number sequence, and a voice input command at the mobile terminal.

16. The system according to claim 1, wherein the respective customization application is one of at least an application to operate the mobile terminal in a WI-FI mode within a CDMA RF-degraded environment, an application to operate the mobile terminal as a cordless phone, and an application to operate the mobile terminal as a radio frequency remote control device.

17. The system according to claim 1, wherein the system further comprises a menu of customized mobile terminal applications, the menu offered by the network when a demand is received from the mobile terminal.

18. The system according to claim 1, wherein the terminal is a mobile terminal.

19. The system according to claim 1, wherein an application database is stored in the first storage.

20. The system according to claim 1, wherein a subscriber database is stored in the second storage.
